(19) United States
(12) Patent Application Publication
(10) Pub. No.: US 2024/0070140 A1
(43) Pub. Date: Feb. 29, 2024

(54) INFORMATION PROCESSING APPARATUS, INFORMATION PROCESSING METHOD, AND NON-TRANSITORY COMPUTER READABLE MEDIUM

(71) Applicant: FUJIFILM Business Innovation Corp., Tokyo (JP)

(72) Inventor: Yohei TAKATSUKA, Kanagawa (JP)

(73) Assignee: FUJIFILM Business Innovation Corp., Tokyo (JP)

(21) Appl. No.: 18/182,557

(22) Filed: Mar. 13, 2023

(30) Foreign Application Priority Data
Aug. 23, 2022 (JP) 2022-132646

(51) Int. Cl. G06F 16/23

(52) U.S. Cl. CPC G06F 16/2358; G06F 16/2365

(57) ABSTRACT

An information processing apparatus includes a processor configured to, in a case where a relationship between a first value for a first entry field and a second value for a second entry field in past data created in past does not conform to a current rule for a current time on a relationship between a value for the first entry field and a value for the second entry field, output a notification.

### CROSS-REFERENCE TO RELATED APPLICATIONS

This application is based on and claims priority under 35 USC 119 from Japanese Patent Application No. 2022-132646 filed Aug. 23, 2022.

### BACKGROUND

### (i) Technical Field

The present disclosure relates to an information processing apparatus, an information processing method, and a non-transitory computer readable medium.

### (ii) Related Art

In Japanese Unexamined Patent Application Publication No. 2020-52912, a method for extracting data similar to entry data from search target data, the method including extracting data similar to entry data on the basis of a rule on the entry data as well as the degree of matching between search target data and the entry data, is disclosed. In Japanese Patent No. 6146417, an operation support apparatus that displays a screen including an entry region in which a plurality of entry fields are arranged and a reference region in which reference information useful for entry to any one of the plurality of entry fields is arranged, is disclosed.

### SUMMARY

A user may refer to past data created in the past and including a plurality of values for a plurality of entry fields. For example, to enter values into a plurality of entry fields of new data, a user may refer to past data including a plurality of entry fields similar to those of the new data.

A rule on the relationship between a plurality of values may be established for data including a plurality of values for a plurality of entry fields. For example, the rule is that if a value for an entry field “company name” is “AA Corporation”, a value for an entry field “bank account” is “xxxx-xxxx-xxxx-xxxx”. However, the rule is not limited to the above example.

Aspects of non-limiting embodiments of the present disclosure relate to allowing a user to be able to understand whether or not the relationship between a plurality of values for a plurality of entry fields in past data conforms to the current rule.

Aspects of certain non-limiting embodiments of the present disclosure address the above advantages and/or other advantages not described above. However, aspects of the non-limiting embodiments are not required to address the advantages described above, and aspects of the non-limiting embodiments of the present disclosure may not address advantages described above.

According to an aspect of the present disclosure, there is provided an information processing apparatus including a processor configured to, in a case where a relationship between a first value for a first entry field and a second value for a second entry field in past data created in past does not conform to a current rule for a current time on a relationship between a value for the first entry field and a value for the second entry field, output a notification.

### BRIEF DESCRIPTION OF THE DRAWINGS

Exemplary embodiments of the present disclosure will be described in detail based on the following figures, wherein:

FIG. 1 is a schematic diagram of a configuration of an information processing system according to an exemplary embodiment;

FIG. 2 is a schematic diagram of a configuration of a server;

FIG. 3 is a conceptual diagram illustrating an example of contents of a past data DB;

FIG. 4 is a conceptual diagram illustrating an example of contents of a rule DB;

FIG. 5 is a diagram illustrating an example of a past data reference screen;

FIG. 6 is a diagram illustrating a first notification example;

FIG. 7 is a diagram illustrating a second notification example;

FIG. 8 is a diagram illustrating a third notification example; and

FIG. 9 is a flowchart illustrating the flow of a process performed by a server.

### DETAILED DESCRIPTION

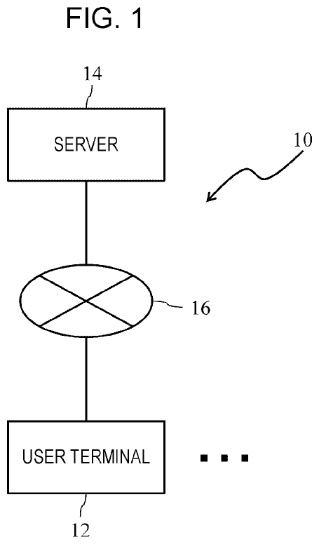

FIG. 1 is a schematic diagram of a configuration of an information processing system 10 according to an exemplary embodiment. The information processing system 10 includes a plurality of user terminals 12 used by a plurality of users (users of a data management service provided by a server 14) and the server 14 as an information processing apparatus. The plurality of user terminals 12 and the server 14 are connected to each other so that they are able to communicate with each other through a communication line 16 such as a local area network (LAN) or a wide area network (WAN).

Each of the user terminals 12 is, for example, a computer such as a personal computer, a tablet terminal, or a smartphone. However, the user terminal 12 is not limited to the above example. The user terminal 12 includes a communication interface for communicating with the server 14 through the communication line 16, an input interface for receiving an instruction from a user, a display that displays various screens, a memory for storing data, a processor configured to execute various processes, and the like.

The server 14 is an apparatus that manages data created in the past by a user (hereinafter, referred to as “past data”) and provides the past data to the user in response to a request from the user. The server 14 according to this exemplary embodiment is an apparatus that manages an electronic document (for example, an application form, an invoice, or the like) as past data created by a user and performs processing using the electronic document (for example, application, invoicing, or the like) in response to a request from the user. However, the server 14 is not limited to the apparatus described above.

Past data is data containing a plurality of entry fields and values for the entry fields. For example, in the case where past data is an invoice, the past data contains entry fields such as “company name”, “bank account”, “payment due date”, and “bookkeeper check date”. In this exemplary embodiment, the server 14 provides template data containing a plurality of entry fields with blank values to the user. In this exemplary embodiment, the server 14 performs processing regarding an invoice. Thus, a piece of template data as a template for an invoice is used as template data. However, in the case where the server 14 handles a plurality of types of data, a plurality of pieces of template data containing a plurality of different entry fields are used. The user creates entered data by entering values into entry fields of the template data, and requests the server 14 for processing regarding the entered data. The server 14 performs processing regarding entered data created by the user as described above and manages the entered data as past data.

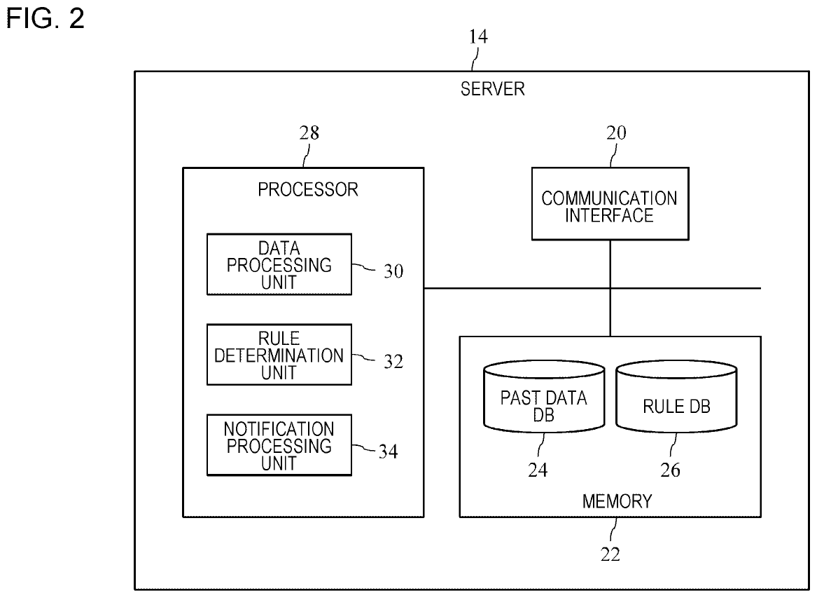

FIG. 2 is a schematic diagram of a configuration of the server 14. The server 14 may be a single computer or may include a plurality of computers that cooperate with each other.

A communication interface 20 includes a network interface card (NIC) or the like. The communication interface 20 exhibits a function for communicating with the user terminals 12 through the communication line 16.

A memory 22 includes a hard disk drive (HDD), a solid state drive (SSD), an embedded multimedia card (eMMC), a read only memory (ROM), a random access memory (RAM), or the like. An information processing program for causing the units that configure the server 14 to operate is stored in the memory 22. The information processing program may be stored in a non-transitory computer-readable recording medium such as a universal serial bus (USB) memory or a compact disc-read only memory (CD-ROM). The server 14 is capable of reading the information processing program from the recording medium mentioned above and executing the information processing program. Furthermore, as illustrated in FIG. 2, a past data database (DB) 24 and a rule DB 26 are stored in the memory 22.

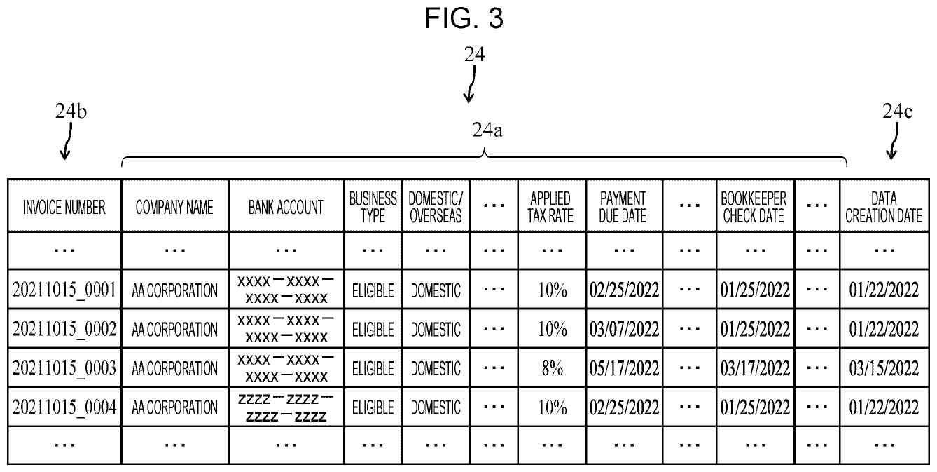

The past data DB 24 is a database in which past data created in the past by a user is stored. FIG. 3 is a diagram illustrating an example of contents of the past data DB 24. In the past data DB 24, a data ID 24b for uniquely identifying past data 24a and creation date information 24c indicating the date on which the past data 24a was created are associated with the past data 24a. As described above, the past data 24a contains a plurality of values (for example, “AA Corporation”, “xxxx-xxxx-xxxx-xxxx”, and so on) for a plurality of entry fields (for example, “company name”, “bank account”, and so on). When the user creates the past data 24a, a processor 28, which will be described later, generates the data ID 24b for uniquely identifying the past data 24a, and stores the past data 24a, the data ID 24b, and the creation date information 24c in association with one another into the past data DB 24. In the case where the server 14 handles a plurality of types of data, a type ID indicating the type (for example, “invoice”) of the past data 24a may be stored into the past data DB 24, in association with the past data 24a.

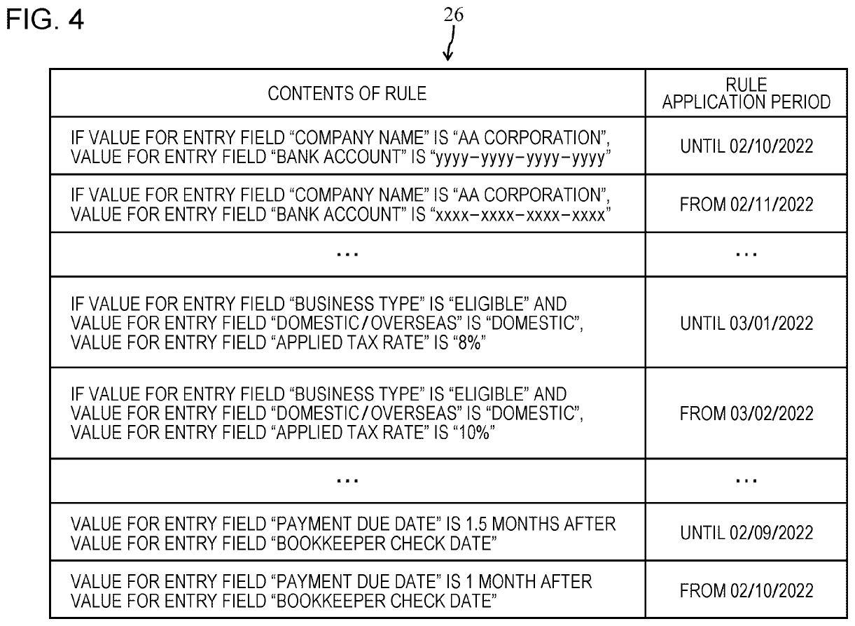

The rule DB 26 is a database in which a rule on the relationship between a plurality of values for a plurality of entry fields of data to be handled by the server 14 is stored. FIG. 4 is a diagram illustrating an example of contents of the rule DB 26. A rule is that, for example, if a value for an entry field “company name” is “AA Corporation”, a value for an entry field “bank account” is “xxxx-xxxx-xxxx-xxxx”. In this example, in the case where a value for the entry field “bank account” in data is “xxxx-xxxx-xxxx-xxxx” when a value for the entry field “company name” in the data is “AA Corporation”, the data conforms to the rule. In contrast, in the case where a value for the entry field “bank account” in data is not “xxxx-xxxx-xxxx-xxxx” when a value for the entry field “company name” in the data is “AA Corporation”, the data does not conform to the rule. A rule is not necessarily on the relationship between three or more values for three or more entry fields. For example, a rule may be that if a value for an entry field “business type” is “eligible” and a value for an entry field “domestic/overseas” is “domestic”, a value for an entry field “applied tax rate” is “10%”.

A rule is created by an administrator of the server 14 and is stored into the rule DB 26. A rule may be changed. Not only the current rule for the current time but a past rule that was applied in the past may also be stored in the rule DB 26. More particularly, contents of a rule and information about a rule application period indicating a period during which the rule was applied are stored, in association with each other, in the rule DB 26. In the case where the server 14 handles a plurality of types of data, a type ID indicating the type (for example, “invoice”) of data to which the rule is applied may also desirably be stored, in association with the contents of the rule, in the rule DB 26.

The processor 28 exhibits functions as a data processing unit 30, a rule determination unit 32, and a notification processing unit 34, based on an information processing program stored in the memory 22.

The data processing unit 30 performs processing regarding data handled by the server 14. For example, the data processing unit 30 provides the template data mentioned above to the user and urges the user to create data (in this exemplary embodiment, an invoice). As described above, a rule on the relationship between a plurality of values for a plurality of entry fields of data may be established. Thus, the data processing unit 30 may be configured to automatically enter a value conforming to the rule. For example, in the case where a rule is defined such that if a value for the entry field “company name” is “AA Corporation”, a value for the entry field “bank account” is “xxxx-xxxx-xxxx-xxxx”, when the user enters “AA Corporation” as a value for the entry field “company name”, the data processing unit 30 may automatically enter “xxxx-xxxx-xxxx-xxxx” as a value for the entry field “bank account”. When the user creates data by entering values for entry fields of the template data, the data processing unit 30 performs processing regarding the created data. In the case where the data is an invoice, the data processing unit 30 performs processing regarding invoicing on the basis of the created invoice. Furthermore, the data processing unit 30 stores, as the past data 24a, the data created by the user into the past data DB 24, in association with the data ID 24b and the creation date information 24c.

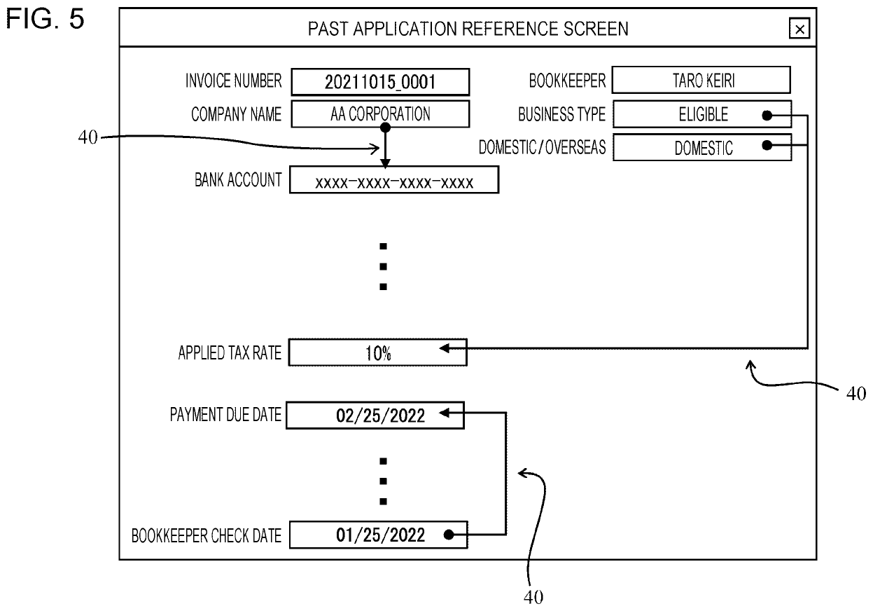

Furthermore, the data processing unit 30 provides past data 24a selected by the user from among a plurality of pieces of past data 24a stored in the past data DB 24 to the user. FIG. 5 is a diagram illustrating a past data reference screen that indicates the past data 24a provided by the data processing unit 30 and displayed on the display of the user terminal 12. Specifically, the user causes the user terminal 12 to transmit a browsing request that specifies desired past data 24a stored in the past data DB 24 to the server 14. In response to the browsing request, the data processing unit 30 transmits information regarding the specified past data 24a to the user terminal 12. The processor of the user terminal 12 causes, based on the received information, a past data reference screen to be displayed on the display of the user terminal 12.

The user is able to simply check the contents of the past data 24a on the past data reference screen. The user is also able to create new data (for example, enter a value into template data provided by the data processing unit 30) with reference to the past data 24a.

As described above, a rule on the relationship between a plurality of values for a plurality of entry fields of the past data 24a may be established. Thus, the data processing unit 30 may cause a relationship icon 40 indicating a plurality of values, the relationship between which is defined in the current rule, to be displayed on the past data reference screen. Specifically, the data processing unit 30 first acquires the current rule (the rule application period of the rule includes the current time) from the rule DB 26. In the case where the server 14 handles a plurality of types of data, the data processing unit 30 identifies the type of the past data 24a on the basis of the past data DB 24 and acquires the current rule corresponding to the type of the past data 24a from the rule DB 26. Next, a plurality of values for a plurality of entry fields, the relationship between which is defined in the current rule, are identified from the past data 24a selected by the user. Then, the relationship icon 40 indicating the relationship between the plurality of identified values is displayed.

For example, in the example of FIG. 5, the relationship between the value “AA Corporation” for the entry field “company name” and the value “xxxx-xxxx-xxxx-xxxx” for the entry field “bank account” is represented by the relationship icon 40. With the relationship icon 40 displayed, the user is able to easily understand a plurality of values for a plurality of entry fields in the past data 24a, the relationship between the plurality of values being defined in the current rule.

Furthermore, in this exemplary embodiment, the relationship icon 40 has an arrow shape. That is, the relationship icon 40 is an icon having a direction. For example, the relationship icon 40 indicates a direction from the value “AA Corporation” for the entry field “company name” toward the value “xxxx-xxxx-xxxx-xxxx” for the entry field “bank account”. This direction represents that the value for the entry field “bank account” is determined based on the value for the entry field “company name” under the rule.

The relationship icon 40 may represent a relationship between a plurality of identified entry fields.

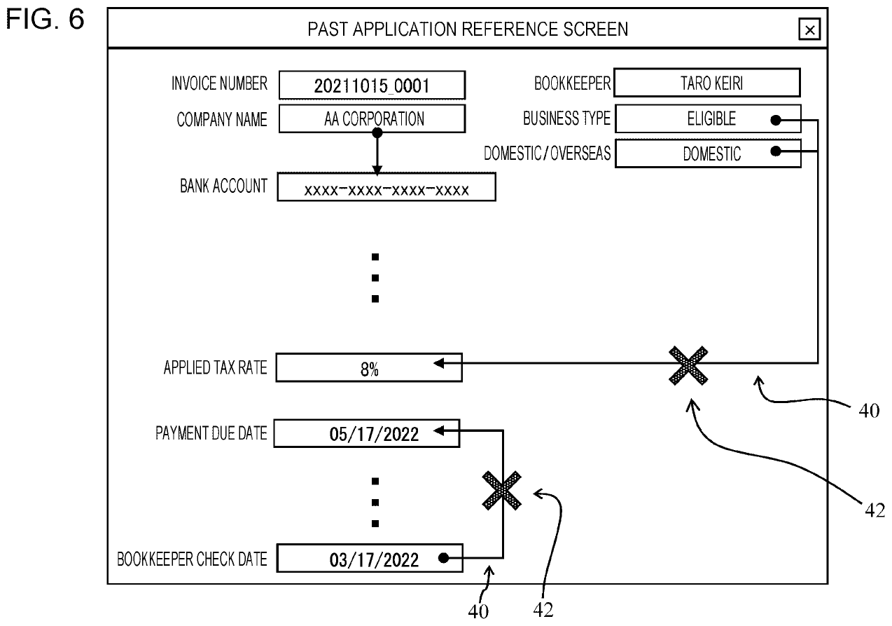

The rule determination unit 32 determines whether or not a plurality of values for a plurality of entry fields in the past data 24a specified by the user conform to the current rule. Furthermore, the notification processing unit 34 provides a notification to the user on the basis of a result of the determination by the rule determination unit 32. The details of processing performed by the rule determination unit 32 and the notification processing unit 34 will be described below with reference to FIGS. 6 to 8.

First, the rule determination unit 32 acquires the current rule (the rule application period for the rule includes the current time) from the rule DB 26. In the case where the server 14 handles a plurality of types of data, the data processing unit 30 identifies, based on the past data DB 24, the type of the past data 24a specified by the user, and acquires the current rule corresponding to the type of the past data 24a from the rule DB 26. Then, a first value for a first entry field and a second value for a second entry field, the relationship between the first value for the first entry field and the second value for the second entry field being defined in the current rule, from the past data 24a selected by the user. In the example of FIG. 6, for example, the rule determination unit 32 identifies the entry field “bookkeeper check date” as the first entry field, the value “03/17/2022” as the first value, the entry field “payment due date” as the second entry field, and the value “05/17/2022” as the second value.

Then, the rule determination unit 32 determines whether or not the relationship between the identified first and second values conforms to the current rule. In this example, it is assumed that the current rule is that a value (date) for the entry field “payment due date” is a month after a value (date) for the entry field “bookkeeper check date”.

In this case, the rule determination unit 32 determines, by the processing described below, whether or not the relationship between the identified first and second values conforms to the current rule. First, the rule determination unit 32 applies the current rule to a value for the entry field “bookkeeper check date” in the past data 24a and calculates a value for the entry field “payment due date” that conforms to the current rule. In this example, “04/17/2022” that is a month after “03/17/2022” is calculated. Then, the rule determination unit 32 compares the calculated value with the value for the entry field “payment due date” in the past data 24a. In the case where, based on a result of the comparison, the calculated value and the value for the entry field “payment due date” are the same, the rule determination unit 32 determines that the relationship between the identified first and second values conforms to the current rule. In contrast, in the case where the calculated value and the value for the entry field “payment due date” are not the same, the rule determination unit 32 determines that the relationship between the identified first and second values does not conform to the current rule.

In the case where the rule determination unit 32 determines that the relationship between the first value and the second value does not conform to the current rule, the notification processing unit 34 outputs a notification to the user who has selected the past data 24a. In the example of FIG. 6, the value “05/17/2022” for the entry field “payment due date” is not a month after the value “03/17/2022” for the entry field “bookkeeper check date”, and the relationship between the first value and the second value does not conform to the current rule. Thus, the notification processing unit 34 displays a notification icon 42 superimposed on or in the vicinity of the relationship icon 40 indicating the relationship between the value for the entry field “bookkeeper check date” and the value for the entry field “payment due date”. In the example of FIG. 6, the notification icon 42 is an icon of “X” mark. Notification by the notification processing unit 34 is not necessarily implemented by the notification icon 42 (and various icons described later) and may be implemented by other methods.

In the case where the current rule is that if a value for the entry field “business type” is “eligible” and a value for the entry field “domestic/overseas” is “domestic”, a value for the entry field “applied tax rate” is “10%”, the rule determination unit 32 determines that the relationship between “eligible” and “domestic”, which are the first values for the entry fields “business type” and “domestic/overseas” as the first entry fields, and “8%”, which is the second value for the entry field “applied tax rate” as the second entry field, does not conform to the current rule in FIG. 6. Thus, the notification processing unit 34 displays the notification icon 42 superimposed on the relationship icon 40 indicating the relationship between the first and second values.

As described above, by the notification icon 42 caused to be displayed by the notification processing unit 34, the user is able to easily understand that the relationship between the first and second values in the past data 24a does not conform to the current rule. For example, if the user knows, when creating new data with reference to the past data 24a, that the relationship between first and second values in the past data 24a does not conform to the current rule, the user is able to choose not to refer to the relationship between the first and second values.

Furthermore, in this exemplary embodiment, the rule determination unit 32 also determines whether or not the relationship between a plurality of values for a plurality of entry fields in the past data 24a specified by the user, for which it has been determined whether or not the relationship conforms to the current rule, conforms to a past rule for the time at which the past data 24a was created, in other words, for the time at which the plurality of values were entered. A case where the relationship between the plurality of values in the past data 24a does not conform to the past rule is, for example, a case where a value was entered as a special exception at the time of creation of the past data 24a, (for example, although a rule is that the payment due date is a month after the bookkeeper check date, the payment due date that is against the rule was entered in the past data 24a (invoice) under special circumstances).

In this case, the rule determination unit 32 acquires the past rule from the rule DB 26. Specifically, the rule determination unit 32 refers to the creation date information 24c about the past data 24a in the past data DB 24 and identifies the data creation date of the past data 24a specified by the user. Then, the rule determination unit 32 refers to the rule DB 26 and acquires a rule that was applied on the identified data creation date as the past rule. In the case where the server 14 handles a plurality of types of data, the data processing unit 30 acquires a past rule corresponding to the type of the past data 24a from the rule DB 26. Then, the rule determination unit 32 determines whether or not the relationship between a first value for a first entry field and a second value for a second entry field in the past data 24a selected by the user, for which it has been determined whether or not the relationship conforms to the current rule, conforms to the past rule.

In this case, the rule determination unit 32 determines, by the processing described below, whether or not the relationship between the identified first and second values conforms to the past rule. First, the rule determination unit 32 applies the past rule to the first value for the entry field “bookkeeper check date” as the first entry field in the past data 24a and calculates a value for the entry field “payment due date” that conforms to the past rule. In the case where, based on a result of the comparison, the calculated value and the value for the entry field “payment due date” in the past data 24a are the same, the rule determination unit 32 determines that the relationship between the identified first and second values conforms to the past rule. In contrast, in the case where the calculated value and the value for the entry field “payment due date” in the past data 24a are not the same, the rule determination unit 32 determines that the relationship between the identified first and second values does not conform to the past rule.

It is assumed that the past rule is that a value (date) for the entry field “payment due date” is one and a half month after a value (date) for the entry field “bookkeeper check date”. As described above, the current rule is that the value (date) for the entry field “payment due date” is a month after the value (date) for the entry field “bookkeeper check date”. Thus, the current rule is different from the past rule. In this case, if the value for the entry field “bookkeeper check date” is “03/17/2022” and the value for the entry field “payment due date” is “05/17/2022”, the relationship between these values conforms to neither the current rule nor the past rule.

In contrast, it is assumed that the past rule is that if a value for the entry field “business type” is “eligible” and a value for the entry field “domestic/overseas” is “domestic, a value for the entry field “applied tax rate” is “8%”. As described above, the current rule is that if the value for the entry field “business type” is “eligible” and the value for the entry field “domestic/overseas” is “domestic”, the value for the entry field “applied tax rate” is “10%”. Thus, the current rule is different from the past rule. In this case, if the value for the entry field “business type” is “eligible”, the value for the entry field “domestic/overseas” is “domestic”, and the value for the entry field “applied tax rate” is “8%”, the relationship between these values does not conform to the current rule but conforms to the past rule.

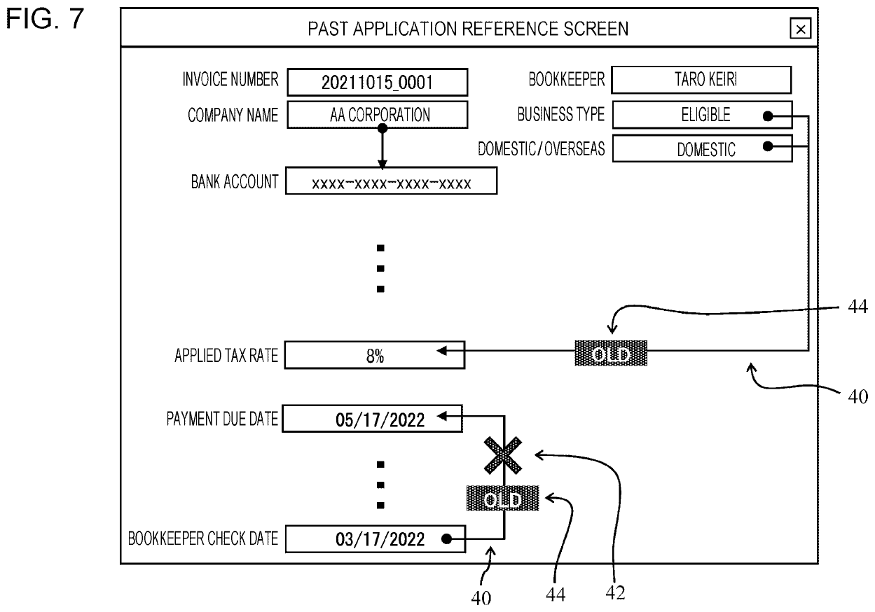

The notification processing unit 34 may output a notification in different manners depending on whether the relationship between first and second values in the past data 24a does not conform to the current rule but conforms to the past rule or conforms to neither the current rule nor the past rule. For example, as illustrated in FIG. 7, in the case where the relationship between the first values “eligible” and “domestic” for the entry fields “business type” and “domestic/overseas” as the first entry fields and the second value “8%” for the entry field “applied tax rate” as the second entry field does not conform to the current rule but conforms to the past rule, the notification processing unit 34 displays a notification icon 44 of a word “OLD” superimposed on or in the vicinity of the relationship icon 40 indicating the relationship between the first and second values. In contrast, in the case where the relationship between the first value “03/17/2022” for the entry field “bookkeeper check date” as the first entry field and the second value “05/17/2022” for the entry field “payment due date” as the second entry field conforms to neither the current rule nor the past rule, the notification processing unit 34 displays the notification icon 42 of the “X” mark and the notification icon 44 of the word “OLD” superimposed on or in the vicinity of the relationship icon 40 indicating the relationship between the first and second values. Thus, the user is able to easily understand whether the relationship between the first and second values does not conform to the current rule but conforms to the past rule or conforms to neither the current rule nor the past rule.

A case where the relationship between the first and second values in the past data 24a conforms to neither the current rule nor the past rule may be a case where the current rule and the past rule are the same (that is, a case where a change has not been made to a rule) or a case where the current rule and the past rule are different (that is, a change has been made to a rule). From this point of view, in the case where the relationship between the first and second values conforms to neither the current rule nor the past rule, the notification processing unit 34 may output a notification in different manners depending on whether the current rule and the past rule are the same or different.

For example, in the case where the relationship between the first and second values in the past data 24a conforms to neither the current rule nor the past rule and the current rule and the past rule are the same, the notification processing unit 34 displays only the notification icon 42 of the “X” mark (see FIG. 6). In contrast, in the case where the relationship between the first and second values conforms to neither the current rule nor the past rule and the current rule and the past rule are different, the notification processing unit 34 displays both the notification icon 42 of the “X” mark and the notification icon 44 of the word “OLD” (see FIG. 7), as described above. Thus, in the case where the relationship between the first and second values in the past data conforms to neither the current rule nor the past rule, the user is able to easily understand whether or not the current rule and the past rule are the same.

Furthermore, when the current rule and the past rule are different, there may be a case where the relationship between a plurality of values in the past data 24a conforms to the current rule but does not conform to the past rule. For example, there may be a case where a plurality of values that did not conform to the past rule were entered under special circumstances at the time of creation of the past data 24a, and after the rule is changed, the plurality of values eventually conforms to the changed current rule. Furthermore, there may be a case where, when the past rule was wrong or a mere formality at the time of creation of the past data 24a, a practically correct plurality of values that do not conform to the past rule were entered, and the rule is then modified to a correct rule.

In such a case, for example, in the case where the user simply checks the contents of the past data, the user may wish to confirm that the relationship between a plurality of values in the past data 24a conforms to the current rule but did not conform to the past rule. In the event of the above case, the notification processing unit 34 may output a notification when the relationship between the first and second values in the past data 24a conforms to the current rule but does not conform to the past rule.

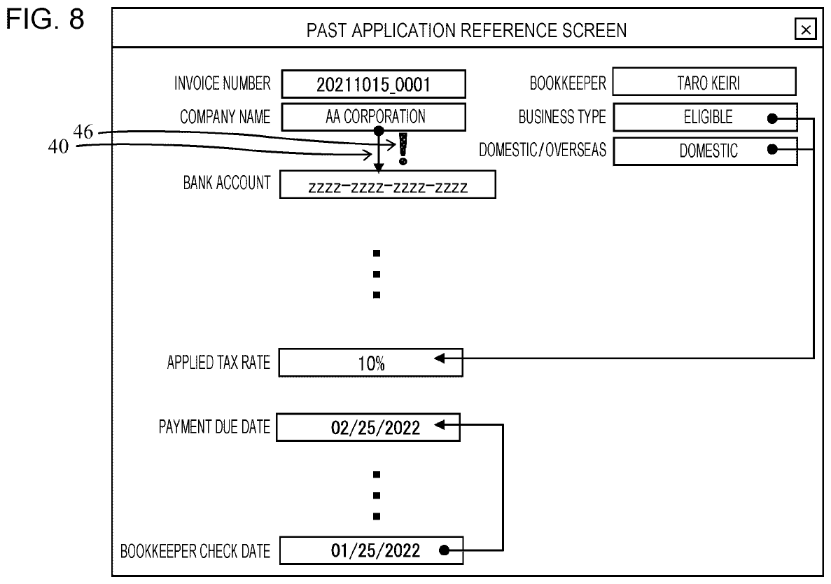

For example, as illustrated in FIG. 8, in the past data 24a, a first value “AA Corporation” is entered for the entry field “company name” as the first entry field and a second value “zzzz-zzzz-zzzz-zzzz” is entered for the entry field “bank account” as the second entry field. It is assumed that the current rule is that if the value for the entry field “company name” is “AA Corporation”, the value for the entry field “bank account” is “zzzz-zzzz-zzzz-zzzz” and the past rule is that if the value for the entry field “company name” is “AA Corporation”, the value for the entry field “bank account” is “yyyy-yyyy-yyyy-yyyy”. In this case, the relationship between the first and second values conforms to the current rule but does not conform to the past rule. Thus, the notification processing unit 34 displays a notification icon 46 of “!” mark superimposed on or in the vicinity of the relationship icon 40 indicating the relationship between the first and second values.

In the case where the relationship between the first and second values in the past data 24a conforms to both the current rule and the past rule, the notification processing unit 34 does not display the notification icon 42, 44, or 46. In this case, only the relationship icon 40 indicating the relationship between the first and second values is displayed (see FIG. 5).

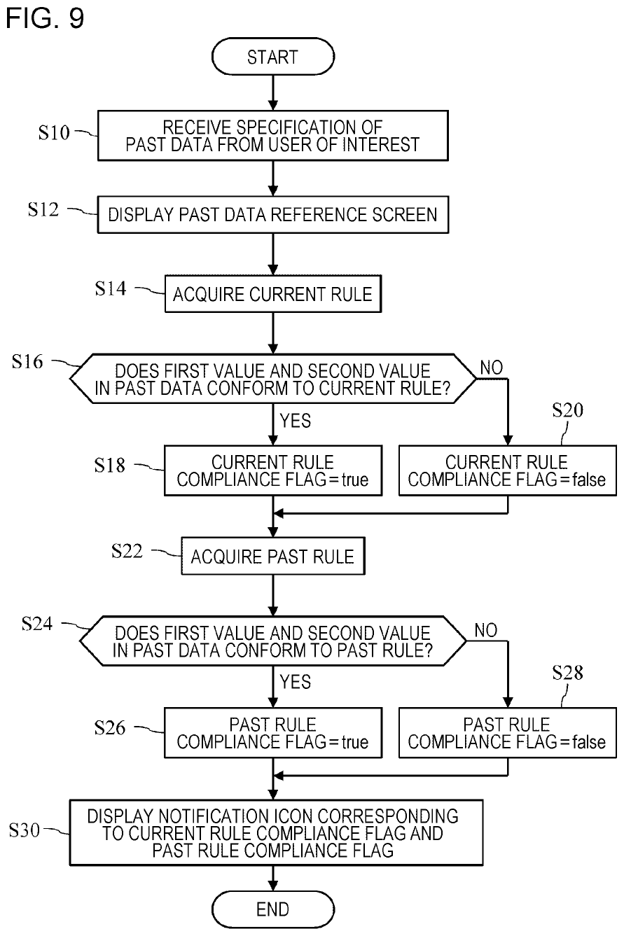

The overview of the configuration of the information processing system 10 according to an exemplary embodiment has been described above. The flow of a process performed by the server 14 will be described below with reference to a flowchart illustrated in FIG. 9.

In step S10, the data processing unit 30 receives a specification of the past data 24a from a user.

In step S12, the data processing unit 30 causes the past data reference screen (see FIG. 5) to be displayed on the display of the user terminal 12 that the user is using.

In step S14, the rule determination unit 32 acquires from the rule DB 26 the current rule for the past data 24a specified in step S10.

In step S16, the rule determination unit 32 determines whether or not the relationship between first and second values in the past data 24a specified in step S10 conforms to the current rule. In the case where the relationship between the first and second values conforms to the current rule, the process proceeds to step S18. In the case where the relationship between the first and second values does not conform to the current rule, the process proceeds to step S20.

In step S18, the rule determination unit 32 sets a value for a current rule compliance flag to “True”. The value “True” represents that the relationship between the first and second values conforms to the current rule. In contrast, in step S20, the rule determination unit 32 sets a value for the current rule compliance flag to “False”. The value “False” represents that the relationship between the first and second values does not conform to the current rule.

In step S22, the rule determination unit 32 acquires from the rule DB 26 a past rule for the past data 24a specified in step S10.

In step S24, the rule determination unit 32 determines whether or not the relationship between the first and second values in the past data 24a specified in step S10 conforms to the past rule. In the case where the relationship between the first and second rules conforms to the past rule, the process proceeds to step S26. In the case where the relationship between the first and second values does not conform to the past rule, the process proceeds to step S28.

In step S26, the rule determination unit 32 sets a value for a past rule compliance flag to “True”. The value “True” represents that the relationship between the first and second values conforms to the past rule. In contrast, in step S28, the rule determination unit 32 sets a value for the past rule compliance flag to “False”. The value “False” represents that the relationship between the first and second values does not conform to the past rule.

In step S30, the notification processing unit 34 displays the notification icon 42, 44, or 46, along with the relationship icon 40 indicating the relationship between the first and second values, on the past data reference screen, in accordance with the values for the current rule compliance flag and the past rule compliance flag set in step S18, S20, S26, or S28, as described below.

In the case where the value for the current rule compliance flag is “True” and the value for the past rule compliance flag is “True”, the notification processing unit 34 does not display the notification icon 42, 44, or 46.

In the case where the value for the current rule compliance flag is “True” and the value for the past rule compliance flag is “False”, the notification processing unit 34 displays the notification icon 46 (see FIG. 8).

In the case where the value for the current rule compliance flag is “False” and the value for the past rule compliance flag is “True”, the notification processing unit 34 displays the notification icon 44 (see FIG. 7).

In the case where the value for the current rule compliance flag is “False”, the value for the past rule compliance flag is “False”, and the current rule and the past rule are different, the notification processing unit 34 displays the notification icons 42 and 44 (see FIG. 7).

In the case where the value for the current rule compliance flag is “False”, the value for the past rule compliance flag is “False”, and the current rule and the past rule are the same, the notification processing unit 34 displays the notification icon 42 (see FIG. 6).

An exemplary embodiment of the present disclosure has been described above.

However, the present disclosure is not limited to the exemplary embodiment described above. Various changes may be made without departing from the spirit of the present disclosure.

For example, the past data DB 24 and the rule DB 26 are stored in the server 14 and the server 14 exhibits functions of the data processing unit 30, the rule determination unit 32, and the notification processing unit 34 in the exemplary embodiment described above. However, all the past data DB 24, the rule DB 26, the data processing unit 30, the rule determination unit 32, and the notification processing unit 34 may be provided in the user terminal 12 so that a process according to an exemplary embodiment of the present disclosure may be performed as a local process at the user terminal 12.

In the embodiments above, the term “processor” refers to hardware in a broad sense. Examples of the processor include general processors (e.g., CPU: Central Processing Unit) and dedicated processors (e.g., GPU: Graphics Processing Unit, ASIC: Application Specific Integrated Circuit, FPGA: Field Programmable Gate Array, and programmable logic device).

In the embodiments above, the term “processor” is broad enough to encompass one processor or plural processors in collaboration which are located physically apart from each other but may work cooperatively. The order of operations of the processor is not limited to one described in the embodiments above, and may be changed.

The foregoing description of the exemplary embodiments of the present disclosure has been provided for the purposes of illustration and description. It is not intended to be exhaustive or to limit the disclosure to the precise forms disclosed. Obviously, many modifications and variations will be apparent to practitioners skilled in the art. The embodiments were chosen and described in order to best explain the principles of the disclosure and its practical applications, thereby enabling others skilled in the art to understand the disclosure for various embodiments and with the various modifications as are suited to the particular use contemplated. It is intended that the scope of the disclosure be defined by the following claims and their equivalents.

### APPENDIX

(((1)))

An information processing apparatus comprising:
a processor configured to:
   in a case where a relationship between a first value for a first entry field and a second value for a second entry field in past data created in past does not conform to a current rule for a current time on a relationship between a value for the first entry field and a value for the second entry field, output a notification.
      (((2)))

The information processing apparatus according to (((1))), wherein the processor is configured to output a notification in different manners depending on whether the relationship between the first value and the second value does not conform to the current rule but conforms to a past rule on a relationship between a value for the first entry field and a value for the second entry field at a time of entry of the first value and the second value or conforms to neither the current rule nor the past rule.

(((3)))

The information processing apparatus according to (((1))), wherein the processor is configured to, in a case where the relationship between the first value and the second value conforms to neither the current rule nor a past rule on a relationship between a value for the first entry field and a value for the second entry field at a time of entry of the first value and the second value, output a notification in different manners depending on whether the current rule and the past rule are same or different.

(((4)))

The information processing apparatus according to (((1))), wherein the processor is configured to, in a case where the relationship between the first value and the second value conforms to the current rule but does not conform to a past rule on a relationship between a value for the first entry field and a value for the second entry field at a time of entry of the first value and the second value, output a notification.

(((5)))

The information processing apparatus according to (((1))), wherein the processor is configured to cause a relationship icon indicating at least one of the first entry field and the second entry field; and the first value and the second value, a relationship between the at least one of the first entry field and the second entry field; and the first value and the second value being defined in the current rule, to be displayed on a display.

(((6)))

The information processing apparatus according to (((5))), wherein the processor is configured to cause a notification icon for the notification to be displayed, along with the relationship icon, on the display.

(((7)))

An information processing program for causing a computer to execute a process comprising: in a case where a relationship between a first value for a first entry field and a second value for a second entry field in past data created in past does not conform to a current rule for a current time on a relationship between a value for the first entry field and a value for the second entry field, outputting a notification.

What is claimed is:

1. An information processing apparatus comprising:
a processor configured to:
in a case where a relationship between a first value for a first entry field and a second value for a second entry field in past data created in past does not conform to a current rule for a current time on a relationship between a value for the first entry field and a value for the second entry field, output a notification.

2. The information processing apparatus according to claim 1, wherein the processor is configured to output a notification in different manners depending on whether the relationship between the first value and the second value does not conform to the current rule but conforms to a past rule on a relationship between a value for the first entry field and a value for the second entry field at a time of entry of the first value and the second value or conforms to neither the current rule nor the past rule.

3. The information processing apparatus according to claim 1, wherein the processor is configured to, in a case where the relationship between the first value and the second value conforms to neither the current rule nor a past rule on a relationship between a value for the first entry field and a value for the second entry field at a time of entry of the first value and the second value, output a notification in different manners depending on whether the current rule and the past rule are same or different.

4. The information processing apparatus according to claim 1, wherein the processor is configured to, in a case where the relationship between the first value and the second value conforms to the current rule but does not conform to a past rule on a relationship between a value for the first entry field and a value for the second entry field at a time of entry of the first value and the second value, output a notification.

5. The information processing apparatus according to claim 1, wherein the processor is configured to cause a relationship icon indicating at least one of the first entry field and the second entry field; and the first value and the second value, a relationship between the at least one of the first entry field and the second entry field; and the first value and the second value being defined in the current rule, to be displayed on a display.

6. The information processing apparatus according to claim 5, wherein the processor is configured to cause a notification icon for the notification to be displayed, along with the relationship icon, on the display.

7. An information processing method comprising:
in a case where a relationship between a first value for a first entry field and a second value for a second entry field in past data created in past does not conform to a current rule for a current time on a relationship between a value for the first entry field and a value for the second entry field, outputting a notification.

8. A non-transitory computer readable medium storing a program causing a computer to execute a process for information processing, the process comprising:
in a case where a relationship between a first value for a first entry field and a second value for a second entry field in past data created in past does not conform to a current rule for a current time on a relationship between a value for the first entry field and a value for the second entry field, outputting a notification.
